(19) United States
(12) Patent Application Publication
(10) Pub. No.: US 2014/0002404 A1
(43) Pub. Date: Jan. 2, 2014

(54) DISPLAY CONTROL METHOD AND APPARATUS

(71) Applicant: Huawei Technologies Co., Ltd., Shenzhen (CN)

(72) Inventor: Peng GE, Shenzhen (CN)

(73) Assignee: Huawei Technologies Co., Ltd., Shenzhen (CN)

(21) Appl. No.: 14/018,051

(22) Filed: Sep. 4, 2013

Related U.S. Application Data
(63) Continuation of application No. PCT/CN2012/076265, filed on May 30, 2012.

(51) Int. Cl. G06F 3/041

(52) U.S. Cl. CPC G06F 3/0412
USPC 345/173

(57) ABSTRACT

Embodiments of the present invention provide a display control method and apparatus. The method includes: determining a distance between a user input part and a touch screen; if the distance is greater than a first threshold, performing no operation; and if the distance is smaller than or equal to the first threshold, adjusting a display scale of a clickable area on the touch screen. Thereby, the displaying of clickable areas on the touch screen may be improved, and misoperations of users may be reduced.

### CROSS-REFERENCE TO RELATED APPLICATIONS

This application is a continuation of International Patent Application No. PCT/CN2012/076265, filed on May 30, 2012, which is hereby incorporated by reference in its entirety.

### FIELD OF THE INVENTION

The present invention relates to the field of information technologies, and in particular, to a display control method and apparatus related to touch operations in a device having a touch screen.

### BACKGROUND OF THE INVENTION

With the development of information technologies, a touch screen has become popular among more and more users for its simple and user-friendly operation interface, and a device including a touch screen (for example, a handset, a portable computer, or the like) have also become a hot research topic.

In the device including a touch screen, users may perform input operations by using a touch screen and clicking each clickable area on the touch screen, for example, inputting a text, starting related operations, and the like.

However, due to limited space of the touch screen, a distance between each clickable area on the touch screen is small; when a user clicks a corresponding area on the touch screen, the user might click another clickable area wrongly, thereby causing misoperations.

### SUMMARY OF THE INVENTION

The objective of the present invention is to provide a display control method and apparatus related to touch operations, where the display control method and apparatus may be applied in a device having a touch screen to improve the displaying of clickable areas on the touch screen and reduce misoperations of users.

An embodiment of the present invention provides a display control method, including: determining a distance between a user input part and a touch screen; if the distance is greater than a first threshold, performing no operation; and if the distance is smaller than or equal to the first threshold, adjusting a display scale of a clickable area on the touch screen.

Another embodiment of the present invention provides a display control apparatus, including: a determining unit, configured to determine a distance between a user input part and a touch screen; an adjusting unit, configured to adjust a display scale of a clickable area on the touch screen if the distance is smaller than or equal to the first threshold.

Still another embodiment of the present invention provides a device having a touch screen, including: the touch screen, configured to receive a touch operation of a user and display a corresponding content to the user; a processor, configured to perform corresponding processing according to the touch operation of the user; and the display control apparatus according to the foregoing embodiments.

### BRIEF DESCRIPTION OF THE DRAWINGS

To illustrate the technical solutions in the embodiments of the present invention more clearly, the accompanying drawings required for describing the embodiments are briefly described in the following. Apparently, the accompanying drawings in the following description show merely some embodiments of the present invention, and persons of ordinary skill in the art may still derive other drawings from these accompanying drawings without creative efforts.

FIG. 1 is a flowchart of a display control method according to an embodiment of the present invention;

FIG. 2 is a processing flowchart of adjusting a display scale of a clickable area on a touch screen according to a projection area of a user input part on the touch screen according to an embodiment of the present invention;

FIG. 3 illustrates a display control apparatus according to an embodiment of the present invention; and

FIG. 4 is a schematic diagram of a device having a touch screen according to an embodiment of the present invention.

### DETAILED DESCRIPTION OF THE EMBODIMENTS

The following describes in detail a display control method and apparatus according to embodiments of the present invention.

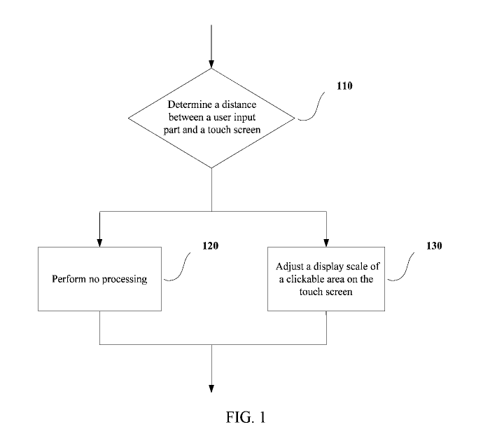

FIG. 1 is a flowchart of a display control method according to an embodiment of the present invention.

As shown in FIG. 1, the display control method according to this embodiment of the present invention includes the following steps.

In step 110, a distance between a user input part and a touch screen may be determined.

The user input part may be any object suitable for inputting through the touch screen, for example, the user input part may be a finger of a user, a stylus pen, or the like.

In addition, preferably, the distance between the user input part and the touch screen may be a vertical distance between the user input part and the touch screen. More preferably, the smallest distance between the user input part and the touch screen in a direction vertical to the touch screen may be defined as the distance between the user input part and the touch screen.

In addition, the distance between the user input part and the touch screen may be determined by using any suitable technology.

For example, the distance between the user input part and the touch screen may be determined according to a build-in electrical field between the user input part and a touch panel of the touch screen.

Referring to FIG. 1, if the distance between the user input part and the touch screen is determined to be greater than a predetermined threshold, no operation is performed in step 120.

The predetermined threshold may be proper values according to different application conditions. In an exemplary embodiment, the predetermined threshold may be 3 mm, 4 mm, 5 mm, or the like.

Referring to FIG. 1, if the distance between the user input part and the touch screen is determined to be smaller than or equal to the predetermined threshold, a display scale of a clickable area on the touch screen may be adjusted in step 130.

Specifically, the display scale of the clickable area on the touch screen may be adjusted according to a projection area of the user input part on the touch screen.

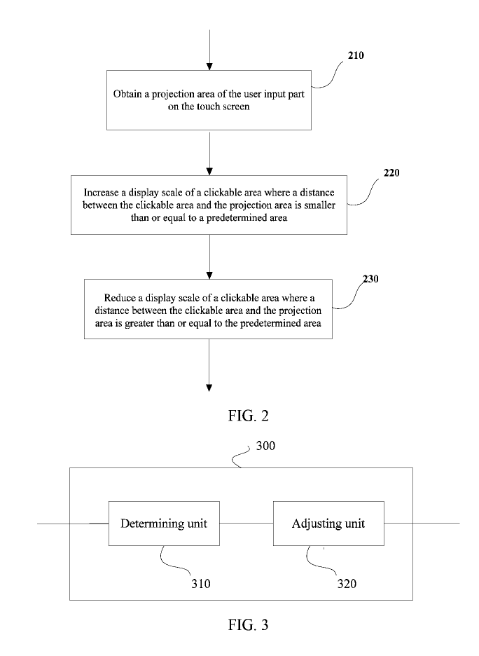

FIG. 2 is a processing flowchart of adjusting a display scale of a clickable area on a touch screen according to a projection area of a user input part on the touch screen according to an embodiment of the present invention.

As shown in FIG. 2, in step 210, a projection area of the user input part on the touch screen may be obtained.

In a specific example, when the distance between the user input part and the touch screen is equal to the predetermined threshold, the projection of a part, of the user input part, closest to the touch screen on the touch screen is used as the projection area.

Then, in step 220, a display scale of a clickable area where a distance between the clickable area and the projection area is smaller than or equal to a predetermined distance may be increased.

According to different application scenarios, the predetermined distance may be any suitable distance, for example, 50 pixels, 100 pixels, 150 pixels, 200 pixels, or the like.

In addition, the distance between the clickable area and the projection area may be a distance in a direction vertical to the edge line of the projection area, or be a distance between the clickable area and the center of the projection area (for example, the center point of the projection area).

In an embodiment of the present invention, the display scale of the clickable area where a distance between the clickable area and the projection area is smaller than or equal to the predetermined distance may be increased by the same time, for example, 1.1 times, 1.2 times, 1.3 times, 1.4 times, 1.5 times, or the like.

In an example, the distance between the projection area and a clickable area may be a linear distance between two closest parts of the two areas. In another example, the distance between the projection area and a clickable area may also be a linear distance between the center of the projection area and the center of the clickable area.

In another embodiment of the present invention, the display scale of each clickable area may also be increased according to the distance between the clickable area and the projection area. For example, in a clickable area where a distance between the clickable area and the projection area is smaller than or equal to a predetermined distance, the display scale of the clickable area may be increased linearly according to the distance between the clickable area and the projection area. That is, the smaller the distance is, the more times the display scale is increased. Alternatively, the display scale of each clickable area may also be increased nonlinearly according to the distance between the clickable area and the projection area, so that the smaller the distance is, the more times the display scale is increased.

Then, in step 230, the display scale of a clickable area where a distance between the clickable area and the projection area is greater than the predetermined distance may be reduced.

According to different application scenarios, the predetermined distance may be any suitable distance, for example, 50 pixels, 100 pixels, 150 pixels, 200 pixels, or the like.

In an embodiment of the present invention, a display scale of the a clickable area where a distance between the clickable area and the projection area is greater than the predetermined distance may be reduced by the same time, for example, 0.9 times, 0.8 times, 0.7 times, 0.6 times, 0.5 times, or the like.

In another embodiment of the present invention, a display scale of each clickable area may also be reduced according to the distance between each clickable area and the projection area. For example, in each clickable area where a distance between the clickable area and the projection area are greater than the predetermined distance, the display scale of each clickable area may be reduced linearly according to the distance between each clickable area and the projection area. That is, the larger the distance is, the more times the display scale is reduced. Alternatively, the display scale of each clickable area may also be reduced nonlinearly according to the distance between each clickable area and the projection area, so that the larger the distance is, the more times the display scale is reduced.

In addition, the embodiment shown in FIG. 2 is only an example, and is not intended to limit the present invention. For example, although step 220 and step 230 in FIG. 2 are executed in sequence, the sequence of steps shown in FIG. 2 is only an example, and in fact, step 220 and step 230 may also be executed at the same time.

Thereby, the display control method applicable to a device having a touch screen according to the embodiments of the present invention is implemented. In the display control method, because the display scale of the clickable area on the touch screen may be adjusted according to the distance between the user input part and the touch screen and the position of the projection area of the user input part on the touch screen, the display scale of the clickable area close to the projection area may be increased, which improves the displaying of clickable areas on the touch screen and reduces misoperations of users.

Similar to the foregoing display control method, the present invention also provides a corresponding display control apparatus.

FIG. 3 illustrates a display control apparatus according to an embodiment of the present invention.

As shown in FIG. 3, a display control apparatus 300 according to an embodiment of the present invention may include a determining unit 310 and an adjusting unit 320.

The determining unit may determine a distance between a user input part and a touch screen. As an example, the determining unit 310 may determine the distance between the user input part and the touch screen according to a build-in electrical field between the user input part and a touch panel of the touch screen.

The adjusting unit 320 may adjust a display scale of a clickable area on the touch screen when the distance between the user input part and the touch screen is smaller than or equal to a predetermined threshold.

As a specific example, the adjusting unit 320 may firstly obtain a projection area of the user input part on the touch screen; then, the adjusting unit 320 increases the display scale of the clickable area where a distance between the clickable area and the projection area is smaller than or equal to the predetermined distance and reduces the display scale of the clickable area where a distance between the clickable area and the projection area is greater than the predetermined distance.

Specifically, the adjusting unit 320 may increase the display scale of the clickable area where a distance between the clickable area and the projection area is smaller than or equal to the predetermined distance by the same time, or, the adjusting unit 320 may increase the display scale of the clickable area according to the distance between the clickable area and the projection area. Similarly, the adjusting unit 320 may reduce the display scale of the clickable area where a distance between the clickable area and the projection area is greater than the predetermined distance by the same time, or, the adjusting unit 320 may reduce the display scale of the clickable area according to the distance between the clickable area and the projection area.

Thereby, the display control apparatus applicable to a device having a touch screen according to this embodiment of the present invention is implemented. In the display control apparatus, because the display scale of the clickable area on the touch screen may be adjusted according to the distance between the user input part and the touch screen and the position of the projection area of the user input part on the touch screen, the display scale of the clickable area close to the projection area may be increased, which improves the displaying of clickable areas on the touch screen and reduces misoperations of users.

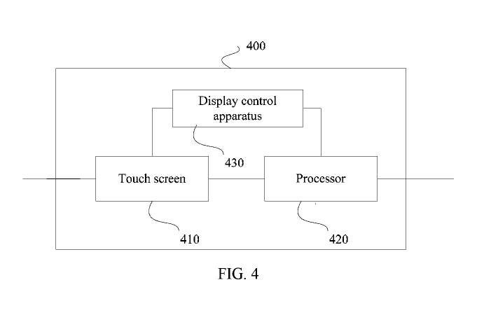

In addition, another embodiment of the present invention further provides a device having a touch screen. FIG. 4 is a schematic diagram of a device having a touch screen according to this embodiment. As shown in FIG. 4, the device includes: a touch screen 410, configured to receive a touch operation of a user and display a corresponding content to the user; a processor 420, configured to perform corresponding processing according to the touch operation of the user; and a display control apparatus 430 according to any one of the foregoing embodiments.

Thereby, in the device having a touch screen according to this embodiment of the present invention, the displaying of clickable areas on the touch screen may be improved, and misoperations of users may be reduced.

What is claimed is:

1. A display control method, comprising:
determining a first distance between a user input part and a touch screen;
if the first distance is greater than a first threshold, performing no operation; and
if the first distance is smaller than or equal to the first threshold, adjusting a display scale of a clickable area on the touch screen.

2. The display control method according to claim 1, wherein the adjusting the display scale of the clickable area on the touch screen comprises:
obtaining a projection area of the user input part on the touch screen;
increasing the display scale of the clickable area where a second distance between the clickable area and the projection area is smaller than or equal to a second threshold; and
reducing the display scale of the clickable area where the second distance between the clickable area and the projection area is greater than the second threshold.

3. The display control method according to claim 2, wherein the increasing the display scale of the clickable area where the second distance between the clickable area and the projection area is smaller than the second threshold comprises:
in the clickable area where the second distance between the clickable area and the projection area is smaller than the second threshold, increasing the display scale of the clickable area according to the second distance between the clickable area and the projection area.

4. The display control method according to claim 2, wherein the reducing the display scale of the clickable area where the second distance between the clickable area and the projection area is greater than the second threshold comprises:
in the clickable area where the second distance between the clickable area and the projection area is greater than the second threshold, reducing the display scale of the clickable area according to the second distance between the clickable area and the projection area.

5. A display control apparatus, comprising:
a determining unit, configured to determine a first distance between a user input part and a touch screen; and
an adjusting unit, configured to adjust a display scale of a clickable area on the touch screen if the first distance is smaller than or equal to a first threshold.

6. The display control apparatus according to claim 5, wherein the adjusting unit is further configured to:
obtain a projection area of the user input part on the touch screen;
increase the display scale of the clickable area where a second distance between the clickable area and the projection area is smaller than or equal to a second threshold; and
reduce the display scale of the clickable area where the second distance between the clickable area and the projection area is greater than the second threshold.

7. The display control apparatus according to claim 6, wherein the adjusting unit is further configured to:
in the clickable area where the second distance between the clickable area and the projection area are smaller than the second threshold, increase the display scale of the clickable area according to the second distance between the clickable area and the projection area.

8. The display control apparatus according to claim 6, wherein the adjusting unit is further configured to:
in the clickable area where the second distance between the clickable area and the projection area is greater than the second threshold, reduce the display scale of the clickable area according to the second distance between the clickable area and the projection area.

9. A device including a touch screen, comprising:
the touch screen, configured to receive a touch operation of a user and display a corresponding content to the user;
a processor, configured to perform corresponding processing according to the touch operation of the user; and
a display control apparatus, comprising:
a determining unit, configured to determine a first distance between a user input part and the touch screen; and
an adjusting unit, configured to adjust a display scale of a clickable area on the touch screen if the first distance is smaller than or equal to a first threshold.

10. The device according to claim 9, wherein the adjusting unit is further configured to:
obtain a projection area of the user input part on the touch screen;
increase the display scale of the clickable area where a second distance between the clickable area and the projection area is smaller than or equal to a second threshold; and
reduce the display scale of the clickable area where the second distance between the clickable area and the projection area is greater than the second threshold.

11. The device according to claim 10, wherein the adjusting unit is further configured to:
in the clickable area where the second distance between the clickable area and the projection area are smaller than the second threshold, increase the display scale of the clickable area according to the second distance between the clickable area and the projection area.

12. The device according to claim 10, wherein the adjusting unit is further configured to:
in the clickable area where the second distance between the clickable area and the projection area is greater than the second threshold, reduce the display scale of the clickable area according to the second distance between the clickable area and the projection area.
